(19) United States
(12) Patent Application Publication
(10) Pub. No.: US 2003/0165307 A1
(43) Pub. Date: Sep. 4, 2003

(54) Transportation protection for optical cables

(76) Inventor: Lennart Liden, Iggesund (SE)

Correspondence Address: JENKENS & GILCHRIST, P.C., Suite 3200, 1445 Ross Avenue, Dallas, TX, 75202-2799, US

(21) Appl. No.: 10/222,105

(22) Filed: Aug. 16, 2002

Related U.S. Application Data
(60) Provisional application No. 60/361,789, filed on Mar. 4, 2002.

(51) Int. Cl. G02B 6/44

(52) U.S. Cl. 385/100

(57) ABSTRACT

Method and apparatus for protecting free ends of optical fibers of an optical fiber cable during transport of the optical fiber cable. The apparatus has a longitudinally divided tube capable of receiving an optical fiber cable and surrounding free ends of optical fibers of a received optical fiber cable. The longitudinally divided tube is capable of being connected to the optical fiber cable during transport of the optical fiber cable, and of being removed from the optical fiber cable after transport of the optical fiber cable for exposing the free ends of the optical fibers for connection of the optical fibers.

This application claims the benefit of co-depending U.S Provisional Patent Application Serial No. 60/361,789 filed Mar. 4, 2002.

### BACKGROUND OF THE INVENTION

1. Field of the Invention

The present invention relates generally to the field of optical fiber cables. More particularly, but not by way of limitation, the present invention relates to a method and apparatus for protecting free ends of optical fibers of an optical fiber cable during transport of the optical fiber cable.

2. Description of Related Art

The free ends of optical fibers of an optical fiber cable should be protected during all handling of the cable. For example, protection is important when an optical fiber cable is being drawn or blown into line pipes/ducts, both indoors and outdoors; when being installed, such as in an antenna tower of a radio base station; and when being prepared for connection of the optical fibers thereof to terminated optical fiber ends.

Rigid PVC-pipes have been used to provide transportation protection for optical fiber cables. A rigid PVC-pipe protects both connectors and optical fibers of an optical fiber cable, as well as parts of an optical fiber cable that have been stripped. Because of its rigidity, however, a PVC-pipe has a tendency to stick in curved portions of line pipes/ducts, and this problem can occur both during drawing and blowing of optical fiber cables in line pipes/ducts. As a result, it is often necessary to remove the PVC-pipe from the cable before the cable can be properly installed in a line pipe/duct that is not completely straight. If the PVC-pipe is removed before installation of the optical fiber cable, however, there is a large risk that connectors and/or optical fibers of the optical fiber cable will be damaged.

Another problem that is encountered with a rigid PVC-pipe is that the interior surface of the pipe needs to be comparatively smooth. If the interior surface of the pipe is not smooth, it is often difficult to bring the terminated optical fibers into line pipes/ducts. It can also be difficult to fix connectors in the PVC-pipe as they often accumulate at the bottom of the pipe when the pipe is vertically oriented.

FIGS. 1 and 2 are simplified views of known transportation protection devices for an optical fiber cable to assist in explaining the present invention. In the device of FIG. 1, in order to be able to draw an optical fiber cable 1 having a bushing 2 in a line pipe/duct, a string 3 or the like is fastened to the optical fiber cable with, for example, a shrink tube 4. During installation in an antenna tower, the string 3 is typically hitched to an installer's belt, and if the string is soft and easy to bend, installation of the optical fiber cable can often be difficult. Also, the shrink tube may be inadequate to reliably retain the string, particularly when a large tensile force must be applied to the string during drawing of the cable.

In the transportation device of FIG. 2, a long, narrow bushing 5 for an optical fiber cable (not shown) is used. An optical fiber cable is inserted through the free end 6 of the bushing, and is led out of the opposite end 7 which has a threaded connector 8, and the ends of optical fibers of the optical fiber cable are terminated with connectors. A shrink tube 9 is applied to the bushing and to part of the optical fiber cable (but not to the threaded connector 8), and is then heated to secure the bushing to the optical fiber cable. A drawback of the transportation device of FIG. 2 is that if the optical fiber cable needs to be adjusted longitudinally for some reason, the shrink tube must be removed; and to do so is both difficult and expensive since a shrink tube cannot be reused.

### SUMMARY OF THE INVENTION

The present invention provides a method and apparatus for protecting free ends of optical fibers of an optical fiber cable during transport of the optical fiber cable. An apparatus for protecting free ends of optical fibers of an optical fiber cable during transport of the optical fiber cable according to an exemplary embodiment of the invention comprises a longitudinally divided tube capable of receiving an optical fiber cable and surrounding free ends of optical fibers of a received optical fiber cable. The longitudinally divided tube is capable of being connected to the optical fiber cable during transport of the optical fiber cable, and of being removed from the optical fiber cable after transport of the optical fiber cable for exposing the free ends of the optical fibers for connection of the optical fibers. The longitudinally divided tube of the transportation protection apparatus of the present invention surrounds and reliably protects the free ends of optical fibers of an optical fiber cable that is received in the tube; and, at the same time, can be easily removed after transport of the optical fiber cable. The longitudinally divided tube permits the optical fibers of the optical fiber cable to be easily exposed for inspection or measurement, to position the optical fibers and their connectors, or for other purposes without removing the apparatus from the cable. Furthermore, the transportation protection apparatus of the invention is highly resistant to outside influences such as, for example, someone stepping on the apparatus, such that the free ends of the optical fibers, as well as connectors on the optical fiber ends, are protected at all times. The longitudinally divided tube of the transportation protection apparatus of the present invention also permits free connectors of the optical fibers to be placed into the tube and fixed therein with, for example, small rubber pads, such that the connectors are prevented from moving around inside the apparatus during transport of the cable.

According to an embodiment of the invention, the longitudinally divided tube comprises a flexible, longitudinally divided tube that is capable of being drawn or blown through curved line pipes/ducts without sticking. In one exemplary embodiment, the tube comprises a corrugated tube having inner and outer corrugated tube members each having a longitudinal slot therein. The slots in the inner and outer tube members are preferably misaligned when the apparatus is used for transportation protection so that the tube will be fully closed around its circumference, but can be aligned to provide access to the interior of the tube when necessary. The corrugated tube is connected to the optical fiber cable by an adjustable bushing, and a drawing loop that is longer than the corrugated tube is connected to both the tube and the bushing. As a result of being connected to the bushing, when the drawing loop is pulled during drawing of the optical fiber cable through a line pipe/duct, tensile forces will be transmitted to the bushing in the direction of the optical fiber cable to prevent undue stresses from being applied to the cable.

### BRIEF DESCRIPTION OF THE DRAWINGS

The foregoing and other advantages of the invention will become apparent upon reading the following detailed description, when taken in conjunction with the following drawings, wherein:

FIG. 1 is a simplified view of a transportation protection device for an optical fiber cable that is known in the art;

FIG. 2 is a simplified view of another transportation protection device for an optical fiber cable that is known in the art;

FIG. 3 is a side elevational view of an apparatus for protecting free ends of optical fibers of an optical fiber cable during transport of the cable according to an exemplary embodiment of the present invention;

FIG. 4 is a side elevational, exploded view illustrating details of the longitudinally divided tube of the apparatus of FIG. 3; and

FIG. 5 is a side elevational, cross sectional view, taken along line 5-5 in FIG. 3, illustrating details of the holding bushing of FIG. 3.

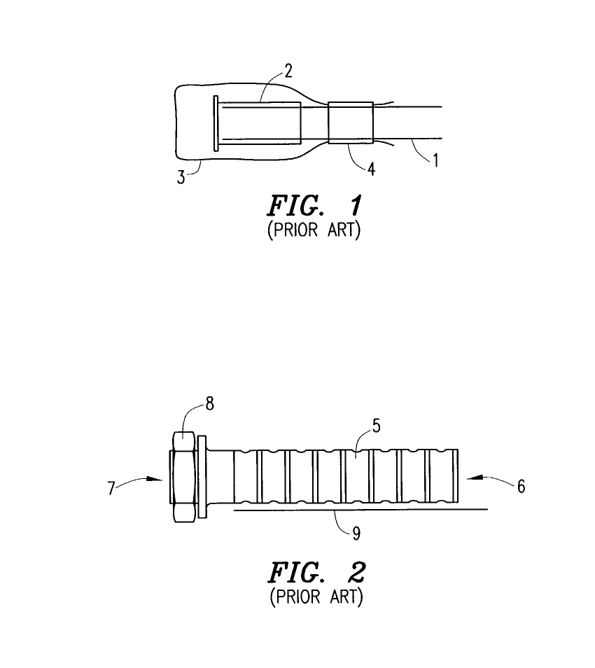

### DETAILED DESCRIPTION OF EXEMPLARY EMBODIMENTS OF THE INVENTION

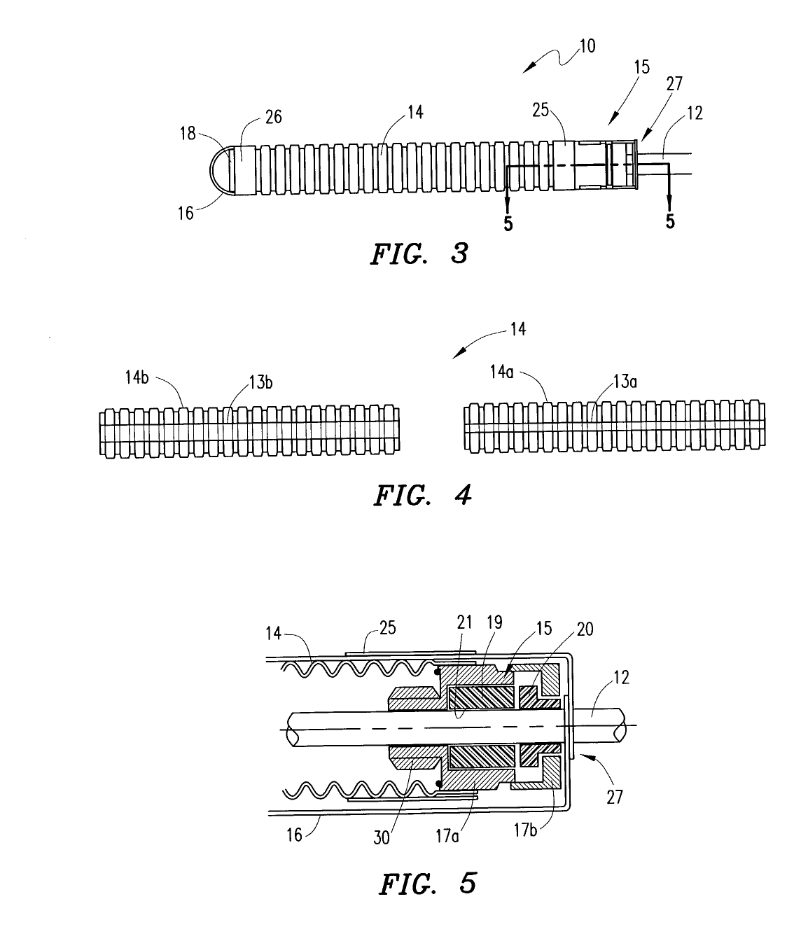

FIG. 3 is a side elevational view of an apparatus for protecting free ends of optical fibers of an optical fiber cable during transport of the cable according to an exemplary embodiment of the present invention. The apparatus is generally designated by reference number 10, and is shown as being connected to an end of an optical fiber cable 12. Apparatus 10 generally includes a longitudinally divided corrugated tube 14, a drawing loop 16 and an end plug 18.

As shown in the exploded view of FIG. 4, corrugated tube 14 comprises inner and outer corrugated tube members 14a and 14b. Each tube member 14a and 14b comprises a tubular-shaped member having a length of, for example, about 30-40 cm, and is formed to have a series of alternating, circular-shaped ridges and grooves that extend the length of the tube. In addition, each tube member 14a and 14b has a longitudinal slot 13a and 13b, respectively, that extends the length of the tube. As clearly shown in FIG. 4, the longitudinal slot 13a of inner tube member 14a is narrower than the longitudinal slot 13b of outer tube member 14b.

Outer tube member 14b is adapted to be positioned around inner tube member 14a to provide tube 14. When the outer tube member is positioned around the inner tube member, the corrugations on the tube members will interlock (i. e., the circular ridges on one tube member will engage the circular grooves on the other tube member). In addition, the tube members are preferably arranged such that the longitudinal slots 13a and 13b thereof are misaligned with one another, for example, positioned on diametrically opposed sides of assembled tube 14. As a result, tube 14 will normally be closed around its entire circumference so as to fully surround and protect the free optical fiber ends and their connectors when optical fiber cable 12 is received in the tube. An end plug 18 is preferably inserted into the open end of tube 14 in order to fully close the tube.

Corrugated tube members 14a and 14b are formed of a material, for example HD-PA (High Density-Polyamide), that will provide tube 14 with both strength and flexibility. Tube 14 constructed of inner and outer tube members 14a and 14b of HD-PA, as described above, is resistant to outside influences such as, for example, someone stepping on the apparatus; and, thus, fully protects the optical fiber cable received in the apparatus, as well as the ends of optical fibers of the cable and any connectors for the optical fiber ends. Tube 14 is also sufficiently flexible to be drawn or blown through line pipes/ducts that are not completely straight without sticking. In addition, the flexibility of tube 14 permits the tube to be pulled apart to expose the optical fiber ends of the optical fiber cable received in the apparatus without removing the apparatus from the cable. In particular, outer tube member 14b can be rotated to align longitudinal slot 13b thereof with longitudinal slot 13a of inner tube member 14a, and the tube members can then be pulled apart to widen the longitudinal slots so as to expose the free ends of the optical fibers for inspection or measurement, to position the optical fibers and their connectors or for other purposes.

In order to prevent movement of the optical fiber ends and their connectors during transport, small non-rigid members, such as foamed rubber pads, not shown, can be placed in tube 14 to fix the optical fibers and their connectors in position therein.

As indicated above, transport protection apparatus 10 is adapted to receive and protect an end of optical fiber cable 12. In accordance with an exemplary embodiment of the invention, apparatus 10 is connected to optical fiber cable 12 by a holding bushing 15 that is capable of being adjustably positioned on optical fiber cable 12. Details of bushing 15 and the manner in which it connects apparatus 10 to cable 12 is best illustrated in the cross-sectional view of FIG. 5.

Holding bushing 15 consists essentially of two threaded co-acting members 17a and 17b, which support sealing members, such as rubber seals 19 and 20, therein. Co-acting members 17a and 17b and their seals 19 and 20, when assembled, define an axial aperture 21 through which optical fiber cable 12 is adapted to extend. More particularly, holding bushing 15 is assembled to optical fiber cable 12 by inserting an end of the cable through axial aperture 21 and then screwing the co-acting members 17a and 17b together. Upon screwing the co-acting members together, seals 19 and 20 press against optical fiber cable 12 and hold the optical fiber cable firmly in the bushing.

Apparatus 10 is connected to bushing 15, and, hence, to optical fiber cable 12, by moving corrugated tube 14 toward and around a portion of the bushing, as shown in FIG. 5, and applying a self-adhering band 25, such as a self-adhering tape, around the end of the tube and a portion of the bushing.

Bushing 15 and its manner of attachment to cable 12 and apparatus 10, makes it unnecessary to utilize a shrink tube to connect the apparatus to the cable. As a result, the position of the bushing can be easily adjusted on the optical fiber cable whenever desired.

Assembly 10 preferably also includes a drawing loop 16 for drawing optical fiber cable 12 through a line pipe/duct. As shown in FIG. 3, drawing loop 16 extends the full length of tube 14 and is connected to tube 14 by an adhesive band 26 and to bushing 15 by adhesive band 25. In addition, the drawing loop is extended around and attached to cable 12 as shown at 27. During pulling of the optical fiber cable, the free ends of the optical fibers of the optical fiber cable are fully protected by apparatus 10, and the cable can be safely pulled through a line pipe/duct without risk of damaging the optical fiber ends and without becoming stuck in a curved portion of the line pipe/duct. Because the drawing loop is connected to bushing 15, an advantageous influence of force on the bushing will be achieved such that tensile forces will be transmitted to the bushing in the direction of optical fiber cable 12 and undue stresses will not be placed on the cable itself

After the optical fiber cable has been pulled or otherwise transported through a line pipe/duct, or otherwise properly positioned, end plug 18 can be removed from tube 14, and tube 14 can be removed from optical fiber cable 12 by removing adhesive band 25. A threaded adapter 30 can be mounted on the end of the bushing, if desired, to connect the bushing and the optical fiber cable to a suitable mounting structure, for example, to attach the cable to a wall of a cabinet for a radio base station.

After apparatus 10 has been removed from the optical fiber cable, the ends of optical fibers of the optical fiber cable are exposed such they can be connected to terminated optical fibers in the usual manner.

While what has been described herein constitutes exemplary embodiments of the present invention, it should be recognized that the invention can be varied in many ways. It should, accordingly, be understood that the present invention should be limited only insofar as is required by the scope of the following claims.

I claim:

1. Apparatus for protecting free ends of optical fibers of an optical fiber cable during transport of the optical fiber cable, said apparatus comprising a longitudinally divided tube capable of receiving an optical fiber cable and surrounding free ends of optical fibers of a received optical fiber cable, said longitudinally divided tube capable of being connected to the optical fiber cable during transport of the optical fiber cable and capable of being removed from the optical fiber cable after transport of the optical fiber cable for exposing said free ends of said optical fibers for connection of the optical fibers.

2. The apparatus according to claim 1, wherein said longitudinally divided tube comprises a flexible, longitudinally divided tube.

3. The apparatus according to claim 2, wherein said flexible, longitudinally divided tube comprises a corrugated, longitudinally divided tube.

4. The apparatus according to claim 3, wherein said corrugated, longitudinally divided tube comprises an inner corrugated tube member and an outer corrugated tube member.

5. The apparatus according to claim 4, wherein said inner corrugated tube member and said outer corrugated tube member are formed of HD-PA (High Density-Polyamide).

6. The apparatus according to claim 4, wherein said inner corrugated tube member and said outer corrugated tube member each includes a longitudinal slot for providing said corrugated, longitudinally divided tube.

7. The apparatus according to claim 6, wherein the longitudinal slot of said inner corrugated tube member is narrower than the longitudinal slot of said outer corrugated tube member.

8. The apparatus according to claim 7, wherein the longitudinal slot of said inner corrugated tube member is normally misaligned with the longitudinal slot of said outer corrugated tube member during transport of said optical fiber cable for enclosing a circumference of said optical fiber cable, and wherein the longitudinal slot of said inner corrugated tube member may be aligned with the longitudinal slot of said outer corrugated tube member to permit said free ends of said optical fiber cable to be exposed.

9. The apparatus according to claim 1, and further including an end plug for closing an end of said longitudinally divided tube when an optical fiber cable is received in said longitudinally divided tube.

10. The apparatus according to claim 2, and further including a drawing loop connected to said flexible, longitudinally divided tube and extending the length of said flexible, longitudinally divided tube for drawing said optical fiber cable through a line tube/duct.

11. The apparatus according to claim 10, wherein said drawing loop is connected to said flexible, longitudinally divided tube by an adhesive tape

12. The apparatus according to claim 10, wherein said flexible, longitudinally divided tube is capable of being connected to said optical fiber cable by a bushing, and wherein said drawing loop is also connected to said bushing.

13. A method for protecting free ends of optical fibers of an optical fiber cable during transport of said optical fiber cable, said method comprising:
receiving an optical fiber cable in a longitudinally divided tube such that said longitudinally divided tube surrounds free ends of optical fibers of the optical fiber cable,
connecting said longitudinally divided tube to the optical fiber cable, and
disconnecting said longitudinally divided tube from said optical fiber cable after transport of said optical fiber cable for exposing said free ends of said optical fibers to permit connection of said optical fibers.

14. The method according to claim 13, wherein said connecting step comprises connecting said longitudinally divided tube to said optical fiber cable with a holding bushing.

15. The method according to claim 14, wherein said connecting step further comprises connecting said longitudinally divided tube to said holding bushing with an adhesive tape.

16. The method according to claim 13, and further including the step of opening said longitudinally divided tube to expose said free ends of said connected optical fiber cable without disconnecting said longitudinally divided tube from said optical fiber cable.

17. The method according to claim 13, and further including the step of placing free connectors of the optical fibers in said longitudinally divided tube during transport of said optical fiber cable.
